(19) United States
(12) Patent Application Publication
(10) Pub. No.: US 2008/0106413 A1
(43) Pub. Date: May 8, 2008

(54) Radio frequency identification connector

(75) Inventor: Bradley A. Rohlf, Lakeville, MN (US)

Correspondence Address: IPLM GROUP, P.A., POST OFFICE BOX 18455, MINNEAPOLIS, MN, 55418, US

(73) Assignee: D B Industries, Inc.

(21) Appl. No.: 11/759,305

(22) Filed: Jun. 7, 2007

Related U.S. Application Data
(60) Provisional application No. 60/856,771, filed on Nov. 3, 2006.

(51) Int. Cl. G08B 23/00

(52) U.S. Cl. 340/572.1

(57) ABSTRACT

A radio frequency identification connector connects radio frequency identification devices to fall protection and fall arrest safety devices.

This application claims the benefit of U.S. Provisional Application Ser. No. 60/856,771, filed Nov. 3, 2006.

### RELATED APPLICATIONS

This disclosure is related to the following co-pending applications: (1) “Retrofittable Radio Frequency Identification Tag” by Brent J. Knoll et al., U.S. Provisional Application Ser. No. 60/811,965, filed Jun. 8, 2006; (2) “Radio Frequency Identification Tag” by Brent J. Knoll et al., U.S. patent application Ser. No. 29/249,952, filed Oct. 27, 2006; (3) “Retrofittable Radio Frequency Identification Connectors” by Brent J. Knoll et al., U.S. Provisional Application Ser. No. 60/856,607, filed Nov. 3, 2006; (4) “Radio Frequency Identification Connectors” by Bradley A. Rohlf, U.S. Provisional Application Ser. No. 60/856,771, filed Nov. 3, 2006; (5) “Connector for Radio Frequency Identification Device” by Bradley A. Rohlf, U.S. patent application Ser. No. 29/279,897, filed May 10, 2007, (6) “Retrofittable Radio Frequency Identification Connector” by Brent J. Knoll et al., Attorney Docket No. 221P182USU1, filed Jun. 7, 2007; (7) “Retrofittable Radio Frequency Identification Connector” by Bradley A Rohlf, Attorney Docket No. 221P201USU1, filed Jun. 7, 2007; (8) “Retrofittable Radio Frequency Identification Connector” by Bradley A, Rohlf, Attorney Docket No. 221P202USU1, filed Jun. 7, 2007; (9) “Retrofittable Radio Frequency Identification Connector” by Bradley A. Rohlf et al., Attorney Docket No. 221P200US01, filed Jun. 7, 2007; and (10) “Radio Frequency Identification Connector” by Bradley A Rohlf, Attorney Docket No 221P187USU1, filed Jun. 7, 2007, which are not admitted as prior art with respect to the present disclosure by its mention in this section.

### FIELD OF THE INVENTION

The present invention relates to a radio frequency identification connector for connecting radio frequency identification devices to fall protection and fall arrest safety devices.

### BACKGROUND OF THE INVENTION

To comply with industry standards, safety devices used for fall protection and fall arrest purposes should be inspected by the user prior to each use and by a competent person other than the user at least annually. To demonstrate compliance with the industry standards, the results of the inspections should be recorded in an inspection and maintenance log for each safety device identified by the model number, the serial number, and the date manufactured or purchased. The inspection and maintenance log should also include information such as the date inspected, the inspection items noted, corrective action, maintenance performed, and the initials of the person who approved the inspection. Other information may also be included such as the dates of the next inspection and maintenance.

For example, some safety devices commonly include labels on which the inspection and maintenance log information may be recorded. However, these labels may become difficult to write on or read should they become soiled. If a separate inspection and maintenance log is kept, it may be difficult to locate the separate log and keep it current, especially if the log is kept in a different location than the safety devices. Therefore, it is desired to provide an inspection and maintenance log that is easily accessible and convenient to use.

The present invention addresses the problems associated with the prior art devices and provides for radio frequency identification connectors for connecting radio frequency identification devices to fall protection and fall arrest safety devices for use with inspection and maintenance logs that are easily accessible and convenient to use

### SUMMARY OF THE INVENTION

One aspect of the present invention provides an identification device connector assembly for connection to a safety device comprising a connector having a first end and a second end. The first end is configured and arranged to be operatively connected to the identification device, and the second end is configured and arranged to be operatively connected to the safety device.

Another aspect of the present invention provides an identification device connector assembly for connection to a device comprising a connector defining a pouch having a cavity, a first end, and a second end. The first end includes an opening providing access to the cavity. The second end is configured and arranged to receive the identification device, and the first end is configured and arranged to be secured to the device thus securing the opening and securing the identification device within the cavity proximate the second end.

Another aspect of the present invention provides an identification device connector assembly for connection to a device comprising a connector strap having a first end and a second end. The identification device is secured to the first end, and the second end is configured and arranged for connection to the device.

Another aspect of the present invention provides a method of securing an identification device to a device having a first portion and a second portion comprising connecting the identification device to a first end of a connector and securing a second end of the connector to the device.

### BRIEF DESCRIPTION OF THE DRAWINGS

FIG. 1 is a top view of a lanyard to which a radio frequency identification connector is operatively connected constructed according to the principles of the present invention;

FIG. 2 is a top view of the radio frequency identification connector shown in FIG. 1 with a portion cut-away revealing a radio frequency identification device contained therein;

FIG. 3 is a top view of a lanyard to which another embodiment radio frequency identification connector is operatively connected constructed according to the principles of the present invention with a portion cut-away revealing a radio frequency identification device contained therein;

FIG. 4 is a top view of the radio frequency identification connector shown in FIG. 3 with a portion cut-away revealing the radio frequency identification device contained therein;

FIG. 5 is a top view of a lanyard to which another embodiment radio frequency identification connector is operatively connected constructed according to the principles of the present invention;

FIG. 6 is a side view of the lanyard to which the radio frequency identification connector is operatively connected shown in FIG. 5;

FIG. 7 is a top view of the radio frequency identification connector shown in FIG. 5;

FIG. 8 is a side view of the radio frequency identification connector shown in FIG. 5;

FIG. 9 is a top view of another embodiment radio frequency identification connector with a portion cut-away revealing the radio frequency identification device contained therein; and

FIG. 10 is a side view of the radio frequency identification connector shown in FIG. 9.

### DETAILED DESCRIPTION OF A PREFERRED EMBODIMENT

Preferred embodiment radio frequency identification connectors constructed according to the principles of the present invention are designated by the numerals 200, 300, 400, and 500 in the drawings.

An example of a suitable radio frequency identification (“RFID”) device that may be used with the embodiments of the present invention is a 134.2 kilohertz half-duplex electronic ID by Allflex USA, Inc. in Dallas Fort Worth, Tex. Another example of a suitable RFID device is disclosed in U.S. Patent Application Publication No. US 2006/0117619 A1, which is incorporated herein by reference. Although the present invention is described herein as a connector for use with a RFID device, it is recognized that the connector may also be used with other suitable identification devices such as, but not limited to, bar codes, serial numbers, and metallic codes. These identification devices may be used individually or in any combination with the connector of the present invention.

As shown in FIG. 1, the radio frequency identification connector 200 connects a radio frequency identification device 205 to a lanyard 208 made of webbing or other suitable material connected to a hook 211. Although a lanyard is shown, it is recognized that the connector may be used to connect the radio frequency identification device to safety harnesses, shock absorbers, and other suitable types of safety devices known in the art. The connector 200 is preferably a tubular piece of webbing or other suitable material including a first end 201, a second end 202, an intermediate portion 203, and a cavity 204. The connector 200 is like a sleeve with the first end 201 and the second end 202 including openings (not shown) that allow access to the cavity 204. The second end 202 is secured with stitching 206 to form a pouch, and the radio frequency identification device 205 is inserted through the opening in the first end 201 and into the cavity 204.

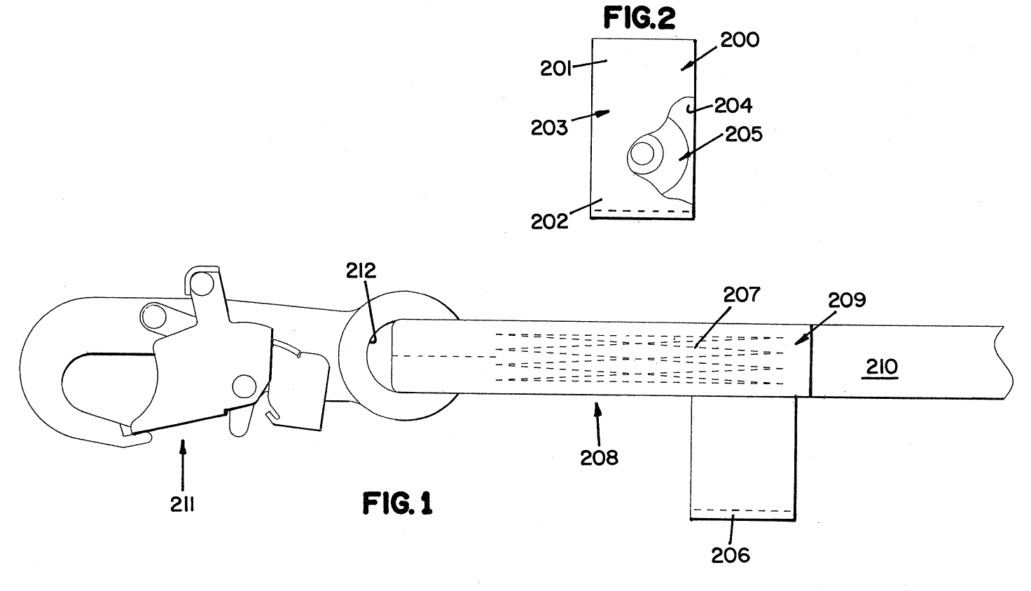

To connect the radio frequency identification device 205 to the lanyard 208, the device 205 is placed within the cavity 204 of the connector 200 as shown in FIG. 2. The end 209 of the lanyard 208 is inserted through an opening 212 of the hook 211 and then folded over onto itself to form two layers with the end 209 and the intermediate portion 210 of the lanyard 208. The first end 201 of the connector 200 is inserted between the two layers of the lanyard 208 and then secured with stitching 207. The stitching 207 extends through the end 209, the first end 201, and the intermediate portion 210 thus securing the device 205 to the lanyard 208. The stitching 207 thus secures the first end 201 so that the radio frequency identification device 205 is contained within the cavity 204 proximate the second end 202 and the intermediate portion 203. It is recognized that a rivet, a grommet, or other suitable fastener could also be used to secure the first end 201 to the lanyard 210.

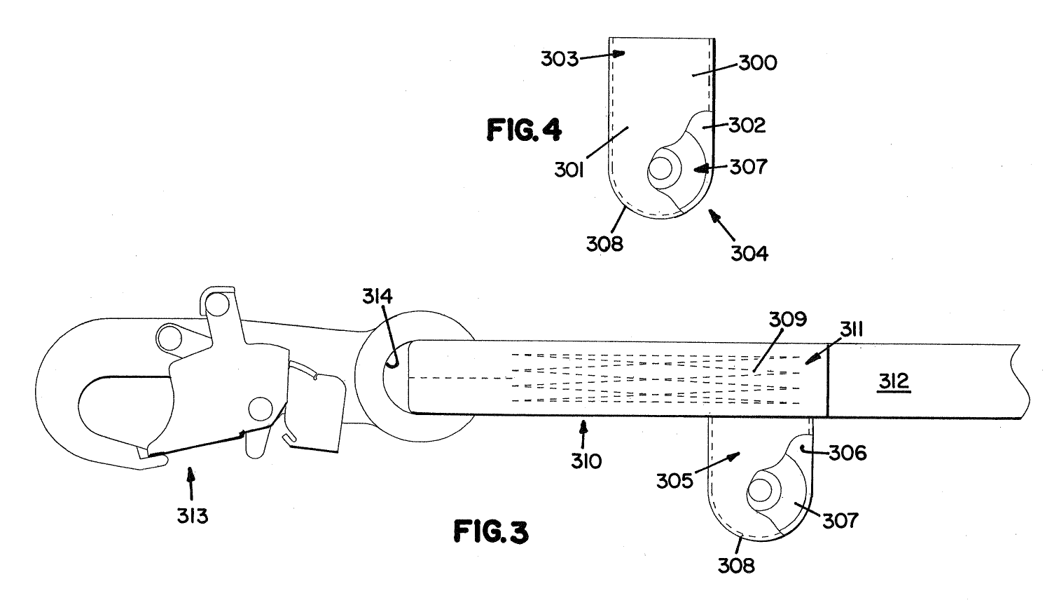

As shown in FIG. 3, the radio frequency identification connector 300 connects a radio frequency identification device 307 to a lanyard 310 made of webbing or other suitable material connected to a hook 313. Although a lanyard is shown, it is recognized that the connector may be used to connect the radio frequency identification device to safety harnesses, shock absorbers, and other suitable types of safety devices known in the art. The connector 300 includes a first side 301 and a second side 302 that are secured together with stitching 308 around three sides to form a pouch with a cavity 306 and an opening (not shown) into the cavity 306, A first end 303 of the connector 300 is not secured with the stitching 308 and includes the opening (not shown) that allows access to the cavity 306 between the sides 301 and 302. A second end 304 is preferably rounded to correspond in shape to the disk-shaped radio frequency identification device 307. The sides 301 and 302 are preferably made of CORDURA™ fabric manufactured by E.I. du Pont De Nemours and Company of Wilmington, Del. The radio frequency identification device 307 is inserted through the opening (not shown) in the first end 303 and into the cavity 306 between the sides 301 and 302. The device 307 is situated proximate the second end 304 with the corresponding shape and an intermediate portion 305.

To connect the radio frequency identification device 307 to the lanyard 310, the device 307 is placed within the cavity 306 of the connector 300 as shown in FIG. 4. The end 311 of the lanyard 310 is inserted through an opening 314 of the hook 313 and then folded over onto itself to form two layers with the end 311 and the intermediate portion 312 of the lanyard 310. The first end 303 of the connector 300 is inserted between the two layers of the lanyard 310 and then secured with stitching 309. The stitching 309 extends through the end 311, the first end 303, and the intermediate portion 312 thus securing the device 307 to the lanyard 310. The stitching 309 thus secures the first end 303 so that the radio frequency identification device 307 is contained within the cavity 306 proximate the second end 304 and the intermediate portion 305. It is recognized that a rivet, a grommet, or other suitable fastener could also be used to secure the first end 303 to the lanyard 310.

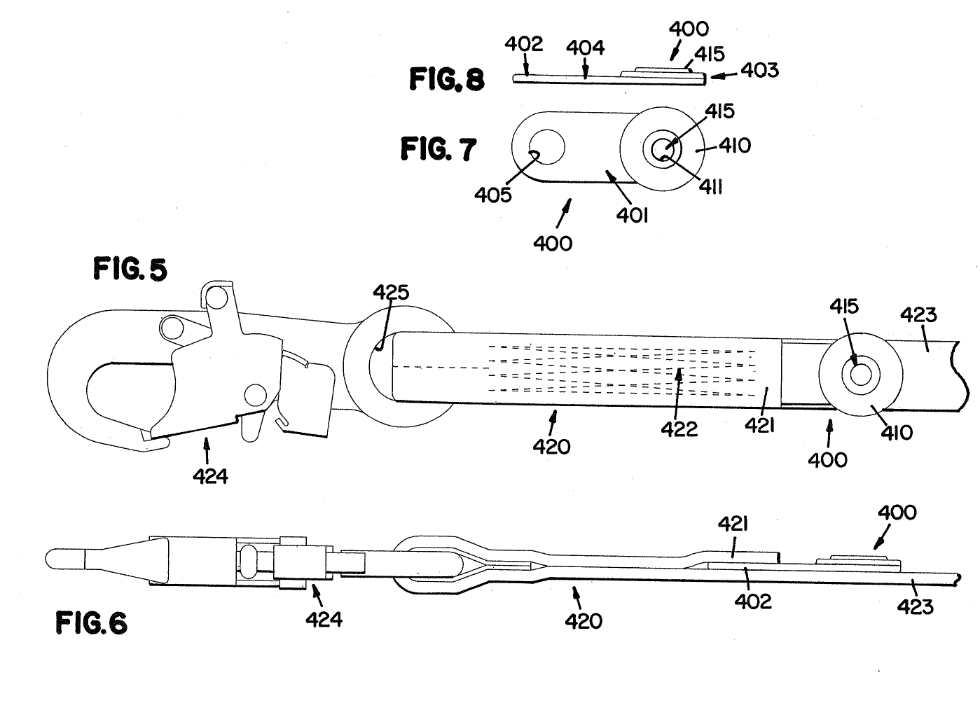

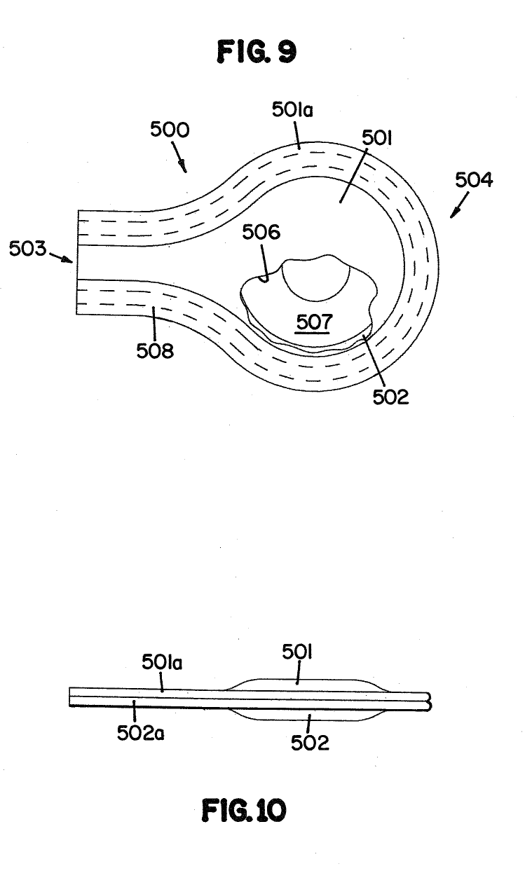

As shown in FIG. 5, the radio frequency identification connector 400 connects a radio frequency identification device 410 to a lanyard 420 made of webbing or other suitable material. Although a lanyard is shown, it is recognized that the connector may be used to connect the radio frequency identification device to safety harnesses, shock absorbers, and other suitable types of safety devices known in the art. The connector 400 includes a strap 401 having a first end 402, a second end 403, and an intermediate portion 404 between the first end 402 and the second end 403. The strap 401 is preferably oval-shaped and made of polyester webbing, nylon fabric, plastic, or any other suitable material. The radio frequency identification device 410 includes an aperture 411 through which a fastener 415 extends to secure the device 410 to the second end 403 of the strap 401. The fastener 415 could be a rivet or any other suitable type of fastener.

The device 410 could be operatively connected to the strap 401 by other suitable containing, capturing, securing, or supporting means. For example, the device 410 could be operatively connected to the strap 401 with stitching, rivets, cable ties, and adhesives. The device 410 and the strap 401 could also be molded out of plastic as an integral piece. For example, an RFID device such as the 134.2 kilohertz half-duplex electronic ID by Allflex USA, Inc, in Dallas Fort Worth, Tex. could include a plastic housing including a strap extending outward from the portion covering the identifying information components of the RFID device.

To connect the radio frequency identification device 410 to the lanyard 420, the device 410 is secured to the strap 401 by the fastener 415. The end 421 of the lanyard 420 is inserted through an opening 425 of the hook 424 and then folded over onto itself to form two layers with the end 421 and an intermediate portion 423 of the lanyard 420. The first end 402 of the connector 400 is inserted between the two layers of the lanyard 420 and then secured with stitching 422. The stitching 422 extends through the end 421, the first end 402, and the intermediate portion 404 thus securing the device 410 to the lanyard 420. It is recognized that a rivet, a grommet, or other suitable fastener could also be used to secure the first end 402 to the lanyard 420 or to another safety device. For example, an aperture 405 may be included proximate the first end 402, and a grommet (not shown) may be used to reinforce the aperture 405. A fastener (not shown), such as a key ring, may be inserted through the aperture 405 and used to interconnect the connector 400 and a safety device.

As shown in FIG. 9, the radio frequency identification connector 500 includes a first side 501, a second side 502, a first end 503, and a second end 504. Optionally, the first side 501 and the second side 502 could include binding 501a and 502a, respectively, around the respective perimeters and connected thereto with stitching. The second end 504 is preferably circular-shaped to correspond with the shape of the radio frequency identification device 507. The first end 503 extends outward from the second end 504 and is tapered inward relative to the second end 504. The radio frequency identification device 507 is placed proximate the second end 504 of either the first side 501 or the second side 502 and then the other side 501 or 502 is placed over the radio frequency identification device 507 thereby sandwiching the radio frequency identification device 507 between the first side 501 and the second side 502. The sides 501 and 502 are then secured together with stitching 508 to contain the radio frequency identification device 507 within a cavity 506. The end proximate the first end 503 does not need to be secured with stitching 508 to contain the radio frequency identification device 507 within the cavity 506. The sides 501 and 502 are preferably made of CORDURA™ fabric manufactured by E.I. du Pont De Nemours and Company of Wilmington, Del. The first end 503 of the connector 500 may be connected to a device with a fastener such as stitching, a rivet, a grommet, or other suitable fastener.

The identification device could be operatively connected to the connector by any suitable containing, capturing, securing, or supporting means. As shown in FIGS. 2, 4, and 9, the identification device is operatively connected to the connector because it is contained within the cavity of the connector. As shown in FIG. 7, the identification device is operatively connected to the connector because it is secured to the connector with a fastener.

Once the connector is connected to the safety device, the connector can be located and the identifying information of the connector can be scanned. The identifying information of the connector is linked to data stored in a computer database where the inspection and maintenance log information can be entered and saved for the safety device. Examples of how this can be accomplished are disclosed in the following co-pending applications filed on even date herewith, the entire contents of which are hereby incorporated by reference in their entirety: (1) “Method of Facilitating Controlled Flow of Information for Safety Equipment Items and Database Related Thereto” by Dean R. Kaartinen et al., U.S. patent application Ser. No. 11/759,148, filed Jun. 6, 2007; (2) “Direct Data Input For Database For Safety Equipment Items and Method” by Dean R. Kaartinen et al., U.S. patent application Ser. No. 11/759,152, filed Jun. 6, 2007; and (3) “Centralized Database of Information Related to Inspection of Safety Equipment Items Inspection and Method” by Dean R. Kaartinen et al., U.S. patent application Ser. No. 11/759,175, filed Jun. 6, 2007. The scanning of the identifying information of the connector makes recordation of the inspection and maintenance log information in the computer database easy because the connector is easily accessible and convenient to use regardless if the safety device is soiled.

The above specification, examples and data provide a complete description of the manufacture and use of the composition of the invention. Since many embodiments of the invention can be made without departing from the spirit and scope of the invention, the invention resides in the claims hereinafter appended.

We claim:

1. An identification device connector assembly for connection to a safety device, comprising
a) a connector having a first end and a second end, the first end being configured and arranged to be operatively connected to the identification device, the second end being configured and arranged to be operatively connected to the safety device.

2. The assembly of claim 1, further comprising the connector including a cavity and the second end including an opening providing access to the cavity, wherein the cavity is configured and arranged to receive the identification device inserted through the opening, and wherein the opening is secured when the second end is operatively connected to the safety device thus securing the identification device within the cavity of the connector proximate the first end.

3. The assembly of claim 1, wherein the connector is a pouch including a cavity within which the identification device contained.

4. The assembly of claim 3, wherein the second end includes an opening providing access to the cavity and wherein the opening is secured when the second end is operatively connected to the safety device thus securing the identification device within the cavity of the connector proximate the first end.

5. The assembly of claim 1, wherein the second end is inserted between two portions of the safety device and stitching secures the second end to the two portions of the safety device.

6. The assembly of claim 1, wherein the connector is a strap, the first end being secured to the identification device and the second end being secured to the safety device.

7. The assembly of claim 6, wherein the strap is made out of plastic and the identification device is molded into the strap to be integral with the strap.

8. The assembly of claim 6, wherein the identification device is secured to the first end with a fastener.

9. The assembly of claim 8, wherein the fastener is a rivet.

10. The assembly of claim 6, wherein the second end is secured to the safety device with stitching.

11. The assembly of claim 10, wherein the second end is inserted between two portions of the safety device and the stitching secures the second end to the two portions of the safety device.

12. The assembly of claim 1, further comprising a first side and a second side of the connector, wherein the identification device is sandwiched between the first side and the second side and contained within a cavity between the first side and the second side.

13. An identification device connector assembly for connection to a device, comprising:
a) a connector defining a pouch having a cavity, a first end, and a second end, the first end including an opening providing access to the cavity, the second end being configured and arranged to receive the identification device, the first end being configured and arranged to be secured to the device thus securing the opening and securing the identification device within the cavity proximate the second end.

14. The assembly of claim 13, wherein the identification device is a radio frequency identification device.

15. The assembly of claim 13, wherein the first end of the connector is configured and arranged to be operatively connected to a safety device.

16. The assembly of claim 15, wherein the first end is operatively connected to the safety device with a fastener selected from the group consisting of stitching, a rivet, and a grommet with a fastener.

17. The assembly of claim 13, wherein the first end is tapered relative to the second end.

18. An identification device connector assembly for connection to a device, comprising:
a) a connector strap having a first end and a second end, the identification device being secured to the first end, the second end being configured and arranged for connection to the device.

19. The assembly of claim 18, wherein the identification device is secured to the first end with a fastener.

20. The assembly of claim 19, wherein the identification device includes an aperture through which the fastener is inserted to interconnect the identification device to the first end.

21. The assembly of claim 20, wherein the fastener is a rivet.

22. The assembly of claim 18, wherein the second end is secured to the device with stitching.

23. The assembly of claim 22, wherein the second end is inserted between two portions of the device and the stitching secures the second end to the two portions of the device.

24. The assembly of claim 18, wherein the connector strap is made out of plastic and the identification device is molded into the connector strap to be integral with the connector strap.

25. A method of securing an identification device to a device having a first portion and a second portion, comprising
a) connecting the identification device to a first end of a connector; and
b) securing a second end of the connector to the device.

26. The method of claim 25, wherein the second end is inserted between the first portion and the second portion of the device and secured with stitching.

27. The method of claim 25, wherein the connector is a pouch including a cavity and an opening providing access to the cavity proximate the second end, the identification device being connected to the first end by placing the identification device within the cavity and positioning the identification device proximate the first end.

28. The method of claim 25, wherein the connector is a strap, the identification device being secured to the first end of the strap with a fastener and the second end of the strap being secured to the device with stitching.
